(19) United States
(12) Patent Application Publication
(10) Pub. No.: US 2014/0204574 A1
(43) Pub. Date: Jul. 24, 2014

(54) Lighting Apparatus and Light Source Unit

(71) Applicant: TOSHIBA LIGHTING & TECHNOLOGY CORPORATION, Yokosuka-shi (JP)

(72) Inventor: Osamu Ebisawa, Yokosuka-shi (JP)

(73) Assignee: TOSHIBA LIGHTING & TECHNOLOGY CORPORATION, Yokosuka-shi (JP)

(21) Appl. No.: 14/031,431

(22) Filed: Sep. 19, 2013

(30) Foreign Application Priority Data
Jan. 24, 2013 (JP) 2013-011287

(51) Int. Cl. F21V 14/02

(52) U.S. Cl. CPC F21V 14/02
USPC 362/235; 362/249.14; 362/249.1

(57) ABSTRACT

According to one embodiment, a lighting apparatus includes a light source unit and a holding unit. The light source unit includes a substrate, light sources, and connection members. The substrate includes a main surface and a wiring pattern. The light sources are arranged on the main surface in a circular pattern, and are electrically connected to the wiring pattern. Each of the connection members is provided on the main surface, includes an insertion unit capable of being penetrated one end of a wire, and holds one end of the wire to electrically connect the wire and the wiring pattern. Each of the connection members is extended in an insertion direction of the one end of the wire, and is disposed between the two adjacent light sources so that the insertion direction intersects with a line segment which connects center portions of the two adjacent light sources.

### CROSS-REFERENCE TO RELATED APPLICATIONS

This application is based upon and claims the benefit of priority from Japanese Patent Application No. 2013-011287, filed on Jan. 24, 2013; the entire contents of which are incorporated herein by reference.

### FIELD

Embodiments described herein relate generally to a lighting apparatus and a light source unit,

### BACKGROUND

There is a lighting apparatus including a light source unit in which a plurality of light sources such as light emitting diodes are disposed on a substrate in a line. A plurality of wires for supplying power are connected to the substrate. In addition, a connection member such as a connector is provided on the substrate, and the connection between the substrate and each wire is performed through the connection member. In the lighting apparatus, it becomes difficult to dispose the connection member on the substrate, with demands for miniaturization of the apparatus, high output, and a large size of a lens for controlling a light distribution angle. Accordingly, in the lighting apparatus and the light source unit, it is desirable to efficiently dispose each light source and the connection member on the substrate.

### BRIEF DESCRIPTION OF THE DRAWINGS

FIG. 1 is a schematic perspective view showing a lighting apparatus according to an exemplary embodiment;

FIGS. 2A and 2B are schematic side views showing a part of a lighting apparatus according to an exemplary embodiment;

FIGS. 3A to 3C are schematic views showing a first frame according to an exemplary embodiment;

FIG. 4 is a schematic view showing a second frame according to an exemplary embodiment;

FIG. 5 is a schematic cross-sectional view showing a first frame and a second frame according to an exemplary embodiment;

FIG. 6 is a schematic perspective view showing a part of a first frame and a part of a second frame according to an exemplary embodiment;

FIG. 7 is a schematic perspective view showing a part of a first frame and a part of a second frame according to an exemplary embodiment;

FIGS. 8A and 8B are schematic top views showing a part of a first frame and a part of a second frame according to an exemplary embodiment;

FIG. 9 is a schematic exploded perspective view showing a lighting main body according to an exemplary embodiment;

FIG. 10 is a schematic partial cross-sectional view showing a lighting main body according to an exemplary embodiment;

FIG. 11 is a schematic cross-sectional view showing a first frame and a holding frame according to an exemplary embodiment;

FIGS. 12A and 12B are schematic views showing a radiator according to an exemplary embodiment;

FIG. 13 is a schematic plan view showing a light source unit according to an exemplary embodiment;

FIGS. 14A and 14B are schematic enlarged views showing a part of a light source unit according to an exemplary embodiment;

FIG. 15 is a schematic cross-sectional view showing a part of a light source unit and a lens unit according to an exemplary embodiment;

FIG. 16 is a schematic perspective view showing a filter according to an exemplary embodiment; and

FIGS. 17A and 17B are schematic perspective views showing a holding frame according to an exemplary embodiment.

### DETAILED DESCRIPTION

In general, according to one embodiment, there is provided a lighting apparatus including a light source unit and a holding unit. The light source unit includes a substrate, a plurality of light sources, and a plurality of connection members. The substrate includes a main surface and a wiring pattern. The plurality of light sources are arranged on the main surface in a circular pattern, and are electrically connected to the wiring pattern. Each of the plurality of connection members is provided on the main surface, includes an insertion unit capable of being penetrated by one end of a wire, and holds the one end of the wire to electrically connect the wire and the wiring pattern. The holding unit holds the light source unit. Each of a plurality of connection members is extended in an insertion direction of the one end of the wire, and is disposed between the two adjacent light sources so that the insertion direction intersects with a line segment which connects center portions of the two adjacent light sources.

Hereinafter, each exemplary embodiment will be described with reference to the drawings.

The drawings are schematically or, otherwise, conceptually shown, and a relationship between a thickness and a width of each portion, a ratio of sizes between portions, and the like are not limited to be the same as actual portions. In addition, even in a case of showing the same portions, dimensions or ratios may be differently shown depending on the drawings.

In the exemplary embodiment and each drawing, the same reference numerals are given to elements which are the same as elements described in the previous drawing, and detailed description will be appropriately omitted.

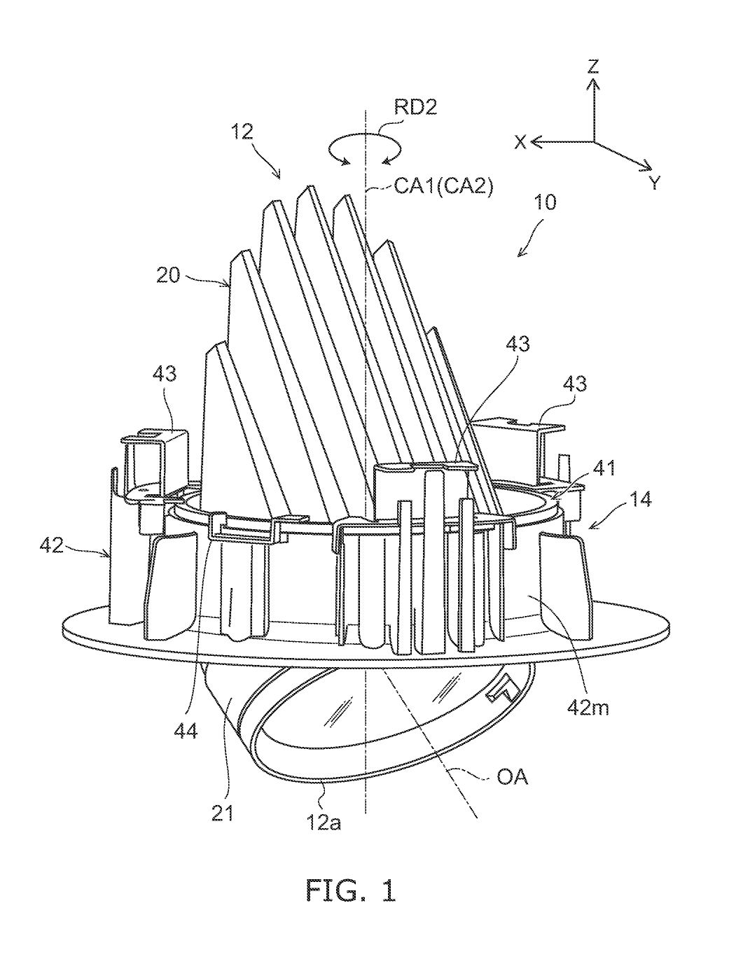

FIG. 1 is a schematic perspective view showing a lighting apparatus according to an exemplary embodiment.

As shown in FIG. 1, a lighting apparatus 10 includes a lighting main body 12 which emits light towards an object and a support 14 which supports the lighting main body 12.

The lighting main body 12 holds light sources inside. The lighting main body 12 includes an irradiation window 12a for exposing light generated from the light sources (hereinafter, referred to as irradiation light). The irradiation light is exposed to the outside of the lighting main body 12 through the irradiation window 12a. Accordingly, an object is irradiated by the irradiation light.

The lighting main body 12 includes a radiator 20, and a holding frame 21, for example. The radiator 20 performs heat radiation generated with light emission of the light source, for example. A metal material having high thermal conductivity such as aluminum is used for the radiator 20, for example. The holding frame 21 holds the radiator 20 or lenses provided inside. The holding frame 21 is tubular, for example. In this example, the holding frame 21 is in a cylindrical shape. In this example, one end of the holding frame 21 is the irradiation window 12a. The radiator 20 is attached to the other end of the holding frame 21. That is, the radiator 20 is provided on the side opposite to the irradiation window 12a.

The support 14 is used for supporting of the lighting main body 12 and is used for attachment of the lighting apparatus 10 to an attachment target such as a ceiling board. The lighting apparatus 10 is attached to a ceiling board in a state where the irradiation window 12a faces downward, for example. The lighting apparatus 10 is embedded in an embedding hole provided on the ceiling board, for example. That is, the lighting apparatus 10 is used as a so-called downlight. Hereinafter, a case of using the lighting apparatus 10 as the downlight will be described as an example. However, the attachment target of the lighting apparatus 10 is not limited to the ceiling board, and an inner wall plate or the like may be used, for example. In addition, for example, the lighting apparatus 10 may be attached to a dedicated attachment jig and the lighting apparatus 10 may be attached to the ceiling or the like through the attachment jig. That is, the attachment target of the lighting apparatus 10 may be the attachment jig or the like.

The support 14 includes a first frame 41 and a second frame 42. The first frame 41 and the second frame 42 are tubular. In this example, the first frame 41 and the second frame 42 are in a cylindrical shape. The support 14 rotatably supports the lighting main body 12 in a state of being inserted through the first frame 41. The first frame 41 rotatably supports the inserted lighting main body 12. In this example, the first frame 41 rotatably supports the holding frame 21. The first frame 41 and the second frame 42 are not limited to the cylindrical shape, and may be in an arbitrary tubular shape such as a square tubular shape, for example.

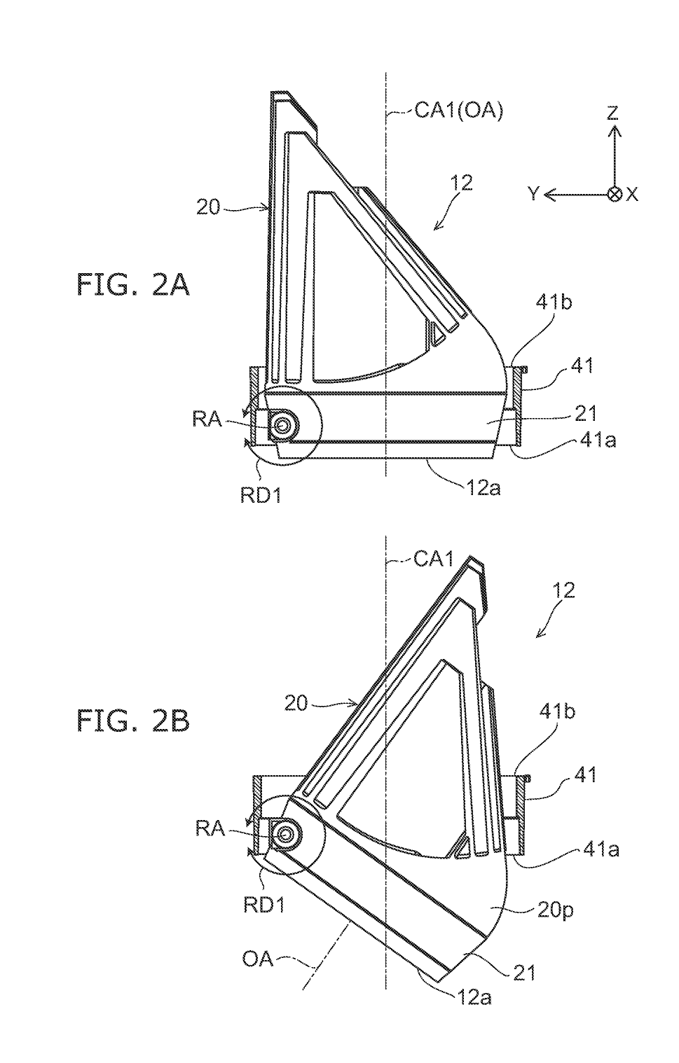

FIGS. 2A and 2B are schematic side views showing a part of the lighting apparatus according to the exemplary embodiment.

FIGS. 2A and 2B show the lighting main body 12 and the first frame 41. FIGS. 2A and 2B show the first frame 41 in a cut state, for visualization of the supported lighting main body 12.

As shown in FIGS. 2A and 2B, the first frame 41 rotates the lighting main body 12 around a rotation axis RA. The rotation axis RA extends in a first direction perpendicular to a first center axis CA1 of the first frame 41. In addition, the rotation axis RA is separated from the first center axis CA1 in a second direction perpendicular to the first center axis CA1 and the first direction. For example, the first center axis CA1 is parallel with an extending direction of the first tubular frame 41, and is an axis which passes through the center of the cross section taken perpendicularly to the extending direction. Hereinafter, a direction of the rotation of the lighting main body 12 around the rotation axis RA is called a “first rotation direction RD1”.

Herein, a direction parallel with the first center axis CA1 is set to a Z axis direction. One direction perpendicular to the Z axis direction is set to an X axis direction. A direction perpendicular to the Z axis direction and the X axis direction is set to a Y axis direction. In this example, the first direction is the X axis direction and the second direction is the Y axis direction. That is, in this example, the rotation axis RA extends in the X axis direction, and is separated from the first center axis CA1 in the Y axis direction.

By rotating the lighting main body 12 in the first rotation direction RD1, the first frame 41 can move the lighting main body 12 to a first position shown in FIG. 2A and to a second position shown in FIG. 2B. In the first position, an optical axis OA of the irradiation light is parallel with the first center axis CA1. On the other hand, in the second position, an optical axis OA of the irradiation light is inclined with respect to the first center axis CA1. Accordingly, in the lighting apparatus 10, the irradiating direction of the irradiation light can be changed. That is, the lighting apparatus 10 is so-called a universal type lighting apparatus. The optical axis OA is, for example, an axis which passes through the center of a beam emitted from the irradiation window 12a.

In addition, when the lighting main body 12 is positioned in the second position, the first frame 41 protrudes a part of the radiator 20 and the irradiation window 12a to the outer side of the first frame 41 from one end 41a of the first frame 41. The one end 41a is an end portion facing the same direction as the irradiation window 12a of the lighting main body 12 in the first position, in two end portions of the first frame 41. In this example, in the second position, entire portions of the irradiation window 12a are protruded to the outer side of the first frame 41 from the one end 41a. For example, when the one end 41a is a lower end facing downwards with respect to a ceiling, the first frame 41 disposes a part 20p of the radiator 20 and the irradiation window 12a to be lower than the one end 41a of the first frame 41.

Accordingly, in the lighting apparatus 10, even when the optical axis OA is inclined with respect to the first center axis CA1, it is possible to suppress shielding of the irradiation light by the apparatus itself or the attachment target such as the ceiling board.

The second frame 42 includes a tubular main body unit 42m capable of being penetrated by the first frame 41. An inner diameter of the main body unit 42m of the second frame 42 is larger than an outer diameter of the first frame 41. The second frame 42 rotatably supports the first frame 41 which is inserted to the main body unit 42m around a second center axis CA2 of the main body unit 42m. Accordingly, in the lighting apparatus 10, the lighting main body 12 is rotated around the rotation axis RA and the first frame 41 and the lighting main body 12 are rotated around the second center axis CA2, and accordingly, it is possible to direct the irradiation light in an arbitrary direction. The second center axis CA2 is, for example, parallel with an extending direction of the main body unit 42m, and is an axis which passes through the center of the cross section taken perpendicularly to the extending direction.

Hereinafter, the direction of the rotation of the first frame 41 and the lighting main body 12 around the second center axis CA2 is called a “second rotation direction RD2”. In this example, the first frame 41 is in a vertically long tubular shape. Accordingly, for example, the lighting main body 12 is rotated in the second rotation direction RD2 to suppress deformation of the first frame 41 when adjusting the direction of the irradiation light, and the adjustment of the direction of the second rotation direction RD2 can be smoothly performed.

The main body unit 42m coaxially supports the first frame 41, for example. That is, in this example, the second center axis CA2 of the main body unit 42m is substantially the same as the first center axis CA1 of the first frame 41. The second center axis CA2 may not be the same as the first center axis CA1,

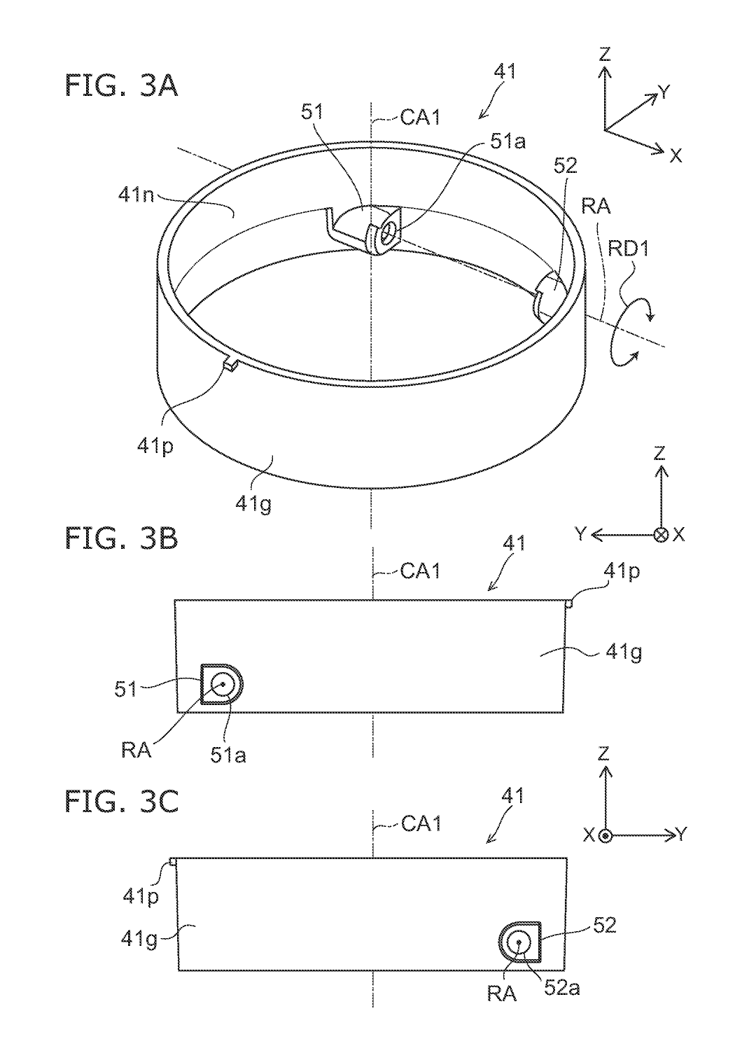

FIGS. 3A to 3C are schematic views showing the first frame according to the exemplary embodiment.

FIG. 3A is a schematic perspective view, FIG. 3B is a schematic right side view, and FIG. 3C is a schematic left side view.

As shown in FIGS. 3A to 3C, a pair of bearing units 51 and 52 which are protruded towards a center direction are provided on an inner side surface 41n of the first frame 41. A penetration hole 51a which extends along the X axis direction is provided on the bearing unit 51. A penetration hole 52a which extends along the X axis direction, in the same manner, is also provided on the bearing unit 52. The penetration hole 52a is provided in a connecting position to the penetration hole 51a in the X axis direction. A diameter of the penetration hole 52a is substantially the same as a diameter of the penetration hole 51a. Accordingly, the rotation axis RA is set to a position separated from the first center axis CA1 in the Y axis direction, by the penetration holes 51a and 52a of the bearing units 51 and 52.

In this example, a distance between the first center axis CA1 and the rotation axis RA along the Y axis direction is shorter than an inner radius of the first frame 41. A distance between the first center axis CA1 and the rotation axis RA along the Y axis direction is shorter than a distance between the first center axis CA1 and the inner side surface 41n along the Y axis direction. Accordingly, for example, the entire portions of the irradiation window 12a can be suitably protruded to the outer side of the first frame 41 from the one end 41a of the first frame 41, in the second position. In addition, for example, it is possible to set the position of the optical axis OA to be substantially the same as the position of the first center axis CA1, in the first position. That is, it is possible to dispose the lighting main body 12 in the center of the first frame 41, in the first position. Accordingly, it is possible to improve the appearance of the lighting apparatus 10, for example.

In addition, a protrusion 41p is provided on the first frame 41. The protrusion 41p is protruded towards the outer side from an outer side surface 41g of the first frame 41. The protrusion 41p is used for regulation of the rotation of the first frame 41 in the second rotation direction RD2.

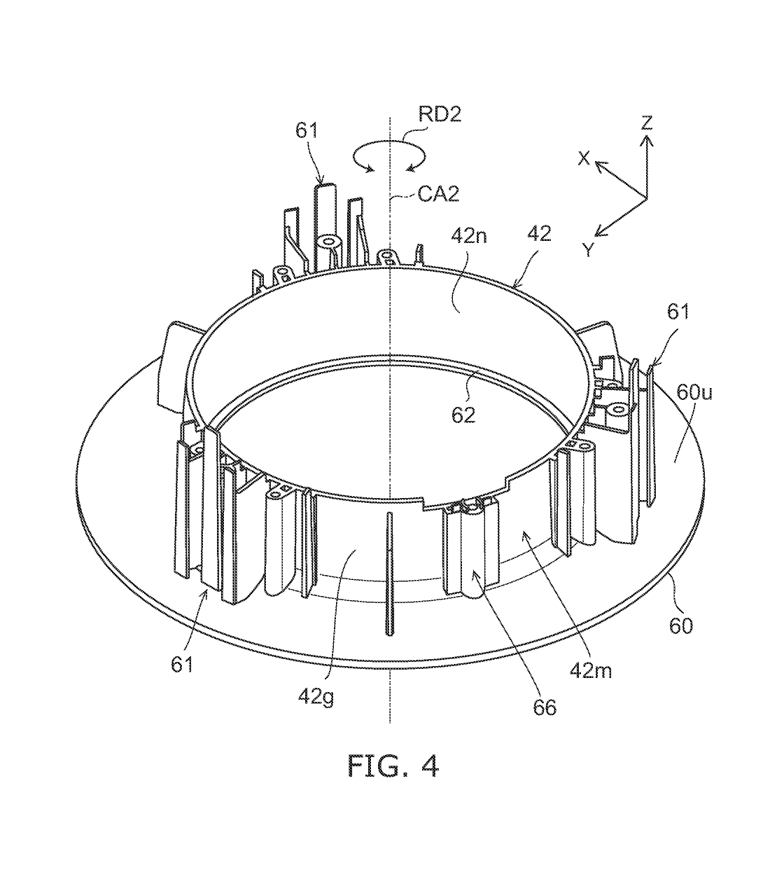

FIG. 4 is a schematic view showing the second frame according to the exemplary embodiment.

A flange portion 60 and a plurality of spring attachment units 61 are provided on the second frame 42. The flange portion 60 is provided on one end of the main body unit 42m. The flange portion 60 is protruded towards the outer side from an outer side surface 42g of the one end of the main body unit 42m. The plurality of spring attachment units 61 are disposed around the second center axis CA2 as a shaft with regular intervals, for example. In this example, three spring attachment units 61 are provided on the second frame 42. The number of the spring attachment units 61 is not limited to three, and an arbitrary number of two or more may be used. An attachment spring (not shown) is provided for each of the plurality of spring attachment units 61. The attachment spring is in a leaf spring shape or a torsional spring shape, for example.

In a case of disposing the lighting apparatus 10 on the ceiling, the embedding hole is provided on the ceiling board, in advance. At that time, a diameter of the embedding hole is larger than an outer diameter of the main body unit 42m and is smaller than a diameter of the flange portion 60. In the lighting apparatus 10, the second frame 42 is inserted through the embedding hole from an indoor side, in a state where the irradiation window 12a faces the indoor side, and an upper surface 60u of the flange portion 60 comes in contact with the ceiling board. In addition, the ceiling board is interposed between the flange portion 60 and the attachment spring. Accordingly, the lighting apparatus 10 is attached to the ceiling board. A lower surface side of the flange portion 60 is exposed to the ceiling. The second frame 42 also functions as a decorated frame for covering the embedding hole and the like.

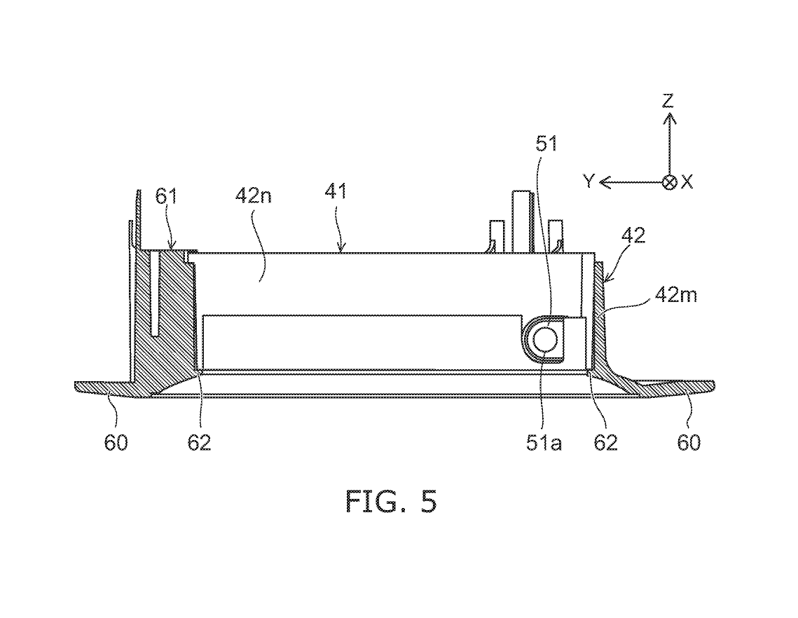

FIG. 5 is a schematic cross-sectional view showing the first frame and the second frame according to the exemplary embodiment.

As shown in FIGS. 4 and 5, a rib 62 is provided on the second frame 42. The rib 62 is provided on the same side as the flange portion 60 of the main body unit 42m. The rib 62 is protruded towards the center direction from the inner side surface 42n of the second frame 42. The inner diameter of the main body unit 42m on a portion where the rib 62 is provided is smaller than the outer diameter of the first frame 41. Accordingly, the first frame 41 which is inserted through the second frame 42 comes in contact with the rib 62, and releasing thereof from the second frame 42 is suppressed. In this example, a circular rib 62 is provided. Without limitation thereto, for example, the plurality of ribs 62 may be provided around the second center axis CA2 as a shaft with regular intervals.

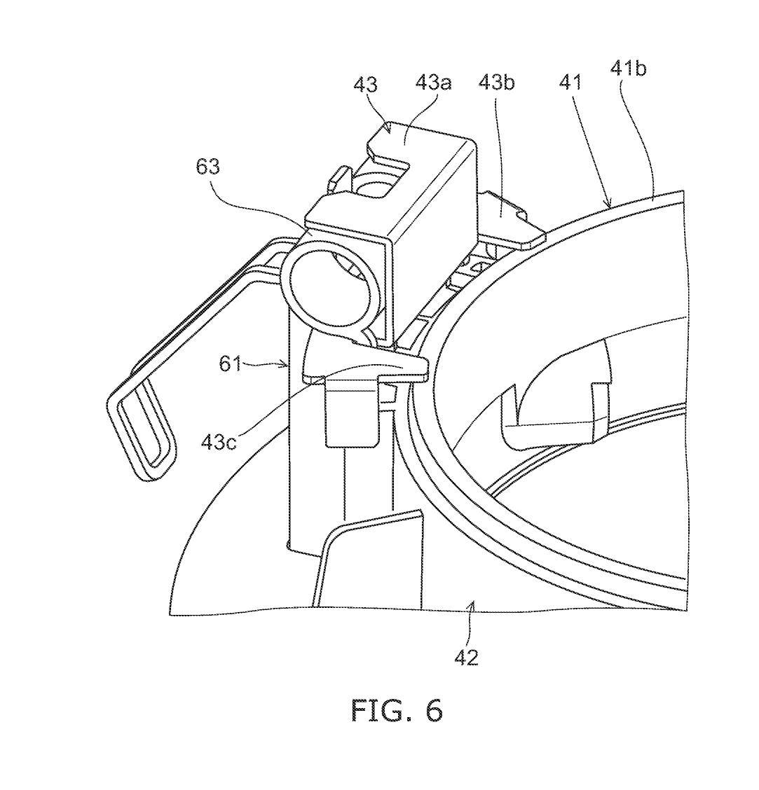

FIG. 6 is a schematic perspective view showing a part of the first frame and a part of the second frame according to the exemplary embodiment.

As shown in FIGS. 1 and 6, a releasing stopper member 43 is attached to each spring attachment unit 61. The releasing stopper member 43 suppresses releasing of the first frame 41 from the second frame 42. In addition, as shown in FIG. 6, in a case where the attachment spring is the torsional spring 63, for example, the releasing stopper member 43 suppresses releasing of the torsional spring 63 from the spring attachment unit 61.

The releasing stopper member 43 is attached to the spring attachment unit 61 by a screw stopper, for example. A metal material is used for the releasing stopper member 43, for example. The releasing stopper member 43 is formed by folding a metal sheet, for example.

The releasing stopper member 43 includes a spring clasping unit 43a which clasps the torsional spring 63, and a pair of frame clasping units 43b and 43c which clasp the first frame 41.

The torsional spring 63 is attached to the spring attachment unit 61, by inserting one end thereof through a groove provided on the spring attachment unit 61. In a state where the releasing stopper member 43 is attached to the spring attachment unit 61, the spring clasping unit 43a comes in contact with a coil portion of the torsional spring 63 attached to the spring attachment unit 61. Accordingly, the coil portion of the torsional spring 63 is interposed by the spring attachment unit 61 and the spring clasping unit 43a, and the torsional spring 63 is held by the spring attachment unit 61.

The frame clasping units 43b and 43c are further inserted to an inner side with respect to the inner side surface 42n of the second frame 42 in a state of being attached to the spring attachment unit 61, and come in contact with one end 41b (the other end) of the first frame 41 which is inserted through the second frame 42. The frame clasping units 43b and 43c are elastically deformed due to the contact with the one end 41b of the first frame 41, for example, and clasp the first frame 41 in the rib 62. Accordingly, the first frame 41 is interposed by the releasing stopper member 43 and the rib 62, and the releasing of the first frame 41 from the second frame 42 is suppressed. Thus, the first frame 41 is supported by the second frame 42 rotatably in the second rotation direction RD2.

In this example, the releasing stopper member 43 has both a function of a releasing stopper of the torsional spring 63 and a function of a releasing stopper of the first frame 41. Without limitation thereto, a member for a releasing stopper of the torsional spring 63 and a member for a releasing stopper of the first frame 41 may be attached to the second frame 42.

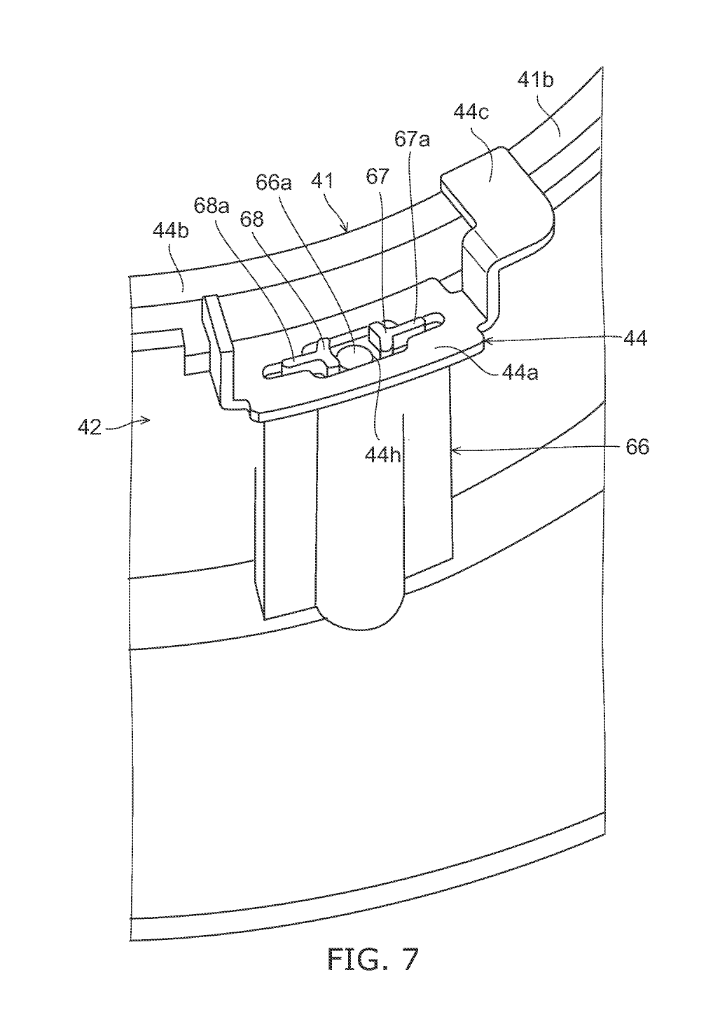

FIG. 7 is a schematic perspective view showing a part of the first frame and a part of the second frame according to the exemplary embodiment.

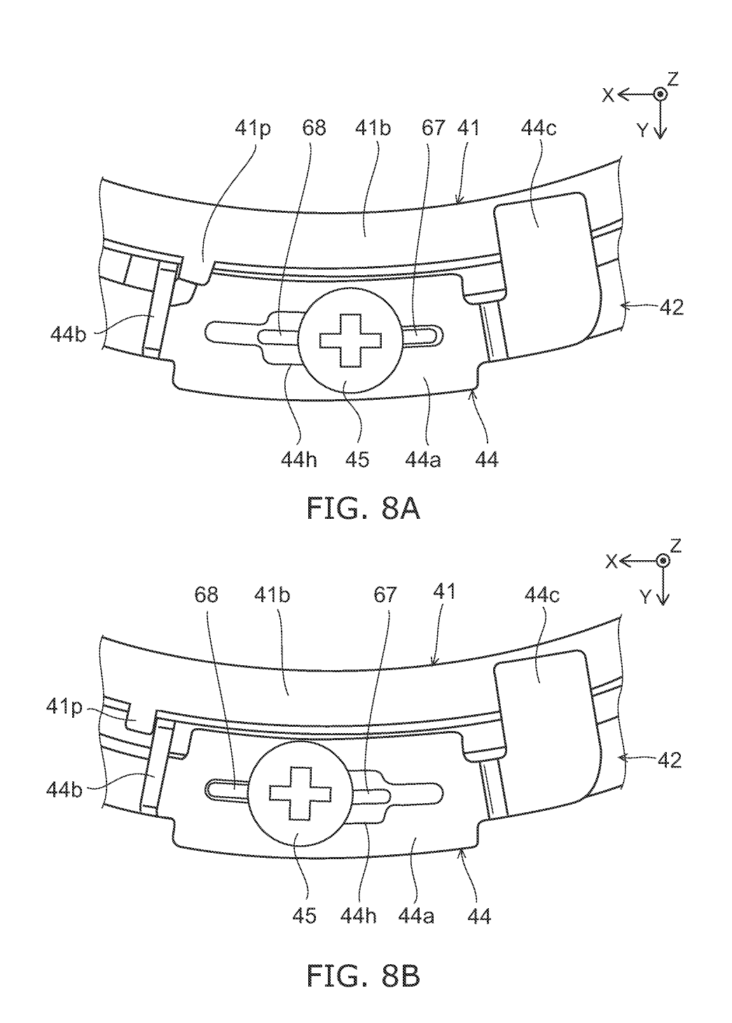

FIGS. 8A and 8B are schematic top views showing a part of the first frame and a part of the second frame according to the exemplary embodiment.

As shown in FIGS. 4, 7, 8A and 8B, a rotation stopper attachment unit 66 for attaching a rotation stopper member 44 is provided on the second frame 42. The rotation stopper member 44 regulates the rotation of the first frame 41 in the second rotation direction RD2 to a predetermined amount or lower.

A pair of protrusions 67 and 68 are provided on the rotation stopper attachment unit 66. The protrusion 67 includes an extension portion 67a which extends along a circumferential direction of a circle having the second center axis CA2 as the center. The protrusion 68 also includes an extension portion 68a which extends along a circumferential direction of a circle having the second center axis CA2 as the center, in the same manner. The extension portion 68a of the protrusion 68 extends to a direction opposite to the extension portion 67a of the protrusion 67. A screw hole 66a is provided on the rotation stopper attachment unit 66. The screw hole 66a is disposed between the protrusions 67 and 68. The rotation stopper member 44 is attached to the rotation stopper attachment unit 66 by a screw 45 (holding member) corresponding to the screw hole 66a.

The rotation stopper member 44 includes a main body unit 44a, an engagement unit 44b, and a frame clasping unit 44c. A metal material is used for the rotation stopper member 44, for example. The engagement unit 44b and the frame clasping unit 44c are formed by folding a metal sheet, for example. A long hole 44h is provided on the main body unit 44a. The protrusions 67 and 68 can be inserted through the long hole 44h.

A thickness of the main body unit 44a is lesser than a height of the protrusions 67 and 68. A length of the long hole 44h is greater than a length from a tip end of the extension portion 67a of the protrusion 67 to a tip end of the extension portion 68a of the protrusion 68. In addition, a width of the long hole 44h is greater than a width of the protrusions 67 and 68, and is lesser than a diameter of a head unit of the screw 45. In a state where the protrusions 67 and 68 pass through the long hole 44h, the rotation stopper member 44 is attached to the rotation stopper attachment unit 66. In the rotation stopper member 44, the releasing from the protrusions 67 and 68 is suppressed by the screw 45. Accordingly, the rotation stopper member 44 is attached to the rotation stopper attachment unit 66 movably in a circumferential direction of a circle having the second center axis CA2 as the center, in a range of the long hole 44h.

The number of the protrusions provided on the rotation stopper attachment unit 66 is not limited to two, or may be one, or three or more. In addition, in this example, the screw 45 is shown as a holding member for suppressing the releasing of the rotation stopper member 44 from the protrusions 67 and 68. The holding member is not limited to the screw 45, and may be an arbitrary member which can suppress the releasing of the rotation stopper member 44, such as a rivet, for example.

In a state where the rotation stopper member 44 is attached to the rotation stopper attachment unit 66, the engagement unit 44b enters the inside of a moving path of the protrusion 41p which is provided on the outer side surface 41g of the first frame 41. The engagement unit 44b is engaged with the protrusion 41p, and regulates the rotation of the first frame 41 in the second rotation direction RD2 to a predetermined amount or lower. Accordingly, for example, it is possible to suppress torsion of the wire for electrically connecting the light source and an external power supply.

In addition, when the protrusion 41p and the engagement unit 44b are engaged with each other, the rotation stopper member 44 moves to the circumferential direction along the protrusions 67 and 68. The rotation stopper member 44 moves to a first regulation position (position shown in FIG. 8A) in which the rotation of the first frame 41 in one direction of the second rotation direction RD2 is regulated, and to a second regulation position (position shown in FIG. 8B) in which the rotation of the first frame 41 in the other direction of the second rotation direction RD2 is regulated.

Accordingly, it is possible to set the rotation amount of the first frame 41 in the second rotation direction RD2 to be equal to or more than 360°, for example. It is possible to set the rotation amount of the first frame 41 in the second rotation direction RD2 to an arbitrary amount such as 365° or 370°, for example. Thus, it is possible to regulate the rotation to suppress torsions of the wire and to direct the irradiation light to an arbitrary direction. For example, restriction of the direction when attaching the lighting apparatus 10 to the ceiling is not necessary, and it is possible to easily perform an attachment operation of the lighting apparatus 10.

The frame clasping unit 44c is further inserted to an inner side with respect to the inner side surface 42n of the second frame 42 in a state of being attached to the rotation stopper attachment unit 66, and comes in contact with one end 41b of the first frame 41 which is inserted through the second frame 42. The frame clasping unit 44c is elastically deformed due to the contact with the one end 41b of the first frame 41, for example, and holds the first frame 41 in the rib 62. That is, the rotation stopper member 44 also functions as a releasing stopper of the first frame 41. The frame clasping unit 44c is provided if necessary, and can be omitted. The rotation stopper member 44 may not have the function of the releasing stopper of the first frame 41.

In addition, a length of the frame clasping unit 44c and a length of the frame clasping units 43b and 43c are longer than a protrusion amount of the protrusion 41p from the outer side surface 41g. That is, the frame clasping unit 44c and frame clasping units 43b and 43c are set aside from the movement path of the protrusion 41p.

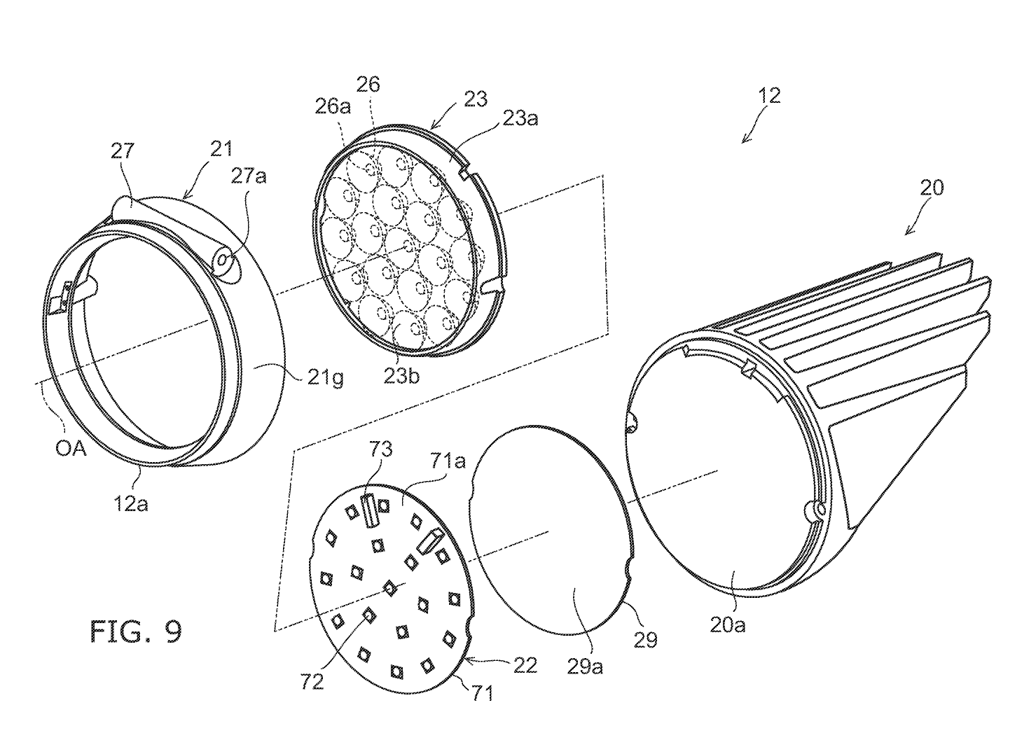

FIG. 9 is a schematic exploded perspective view showing the lighting main body according to the exemplary embodiment.

As shown in FIG. 9, the lighting main body 12 includes the radiator 20 and the holding frame 21, and also includes a light source unit 22 and a lens unit 23.

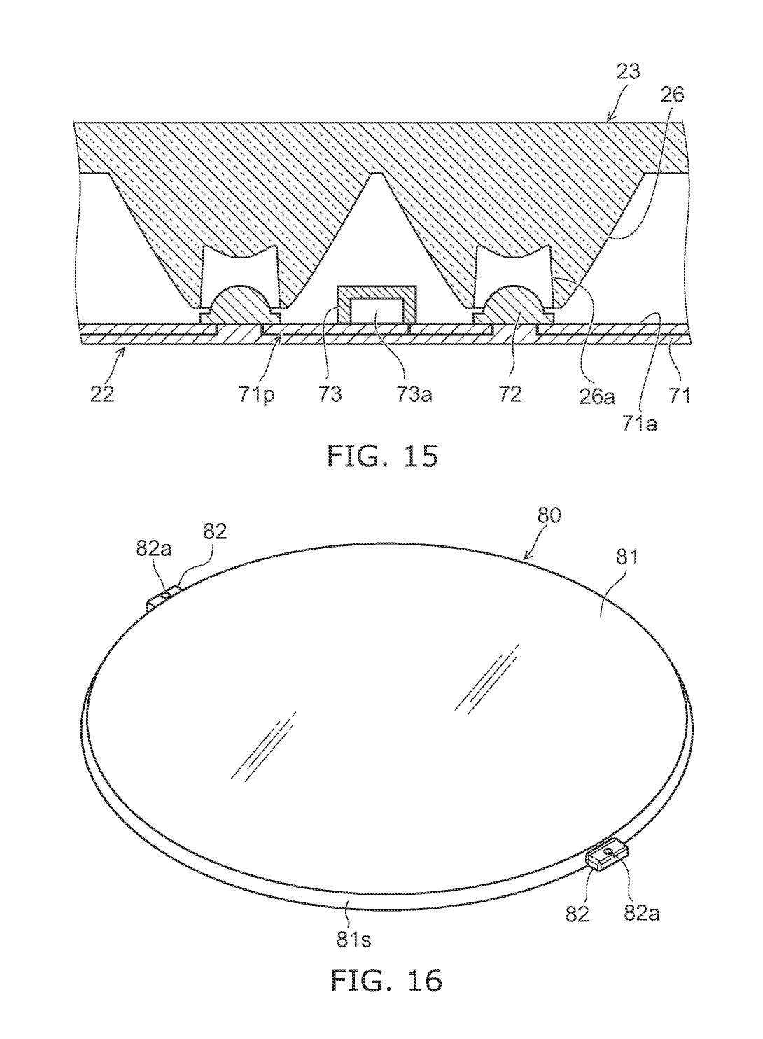

The light source unit 22 includes a substrate 71, a plurality of light sources 72, and a plurality of connection members 73. The substrate 71 includes a main surface 71a and a wiring pattern 71p (see FIG. 15). In this example, the substrate 71 is in a disc shape. The substrate 71 is not limited to a disc shape, and may be in an arbitrary shape.

Each light source 72 is arranged on the main surface 71a in a circular pattern, and is electrically connected to the wiring pattern 71p. In this example, each light source 72 is arranged in a circular ring shape. The disposition of each light source 72 is not limited to the circular ring shape, and for example, may be in a ring shape of polygon. In addition, in this example, each light source 72 is concentrically arranged. Each light source 72 may be concentrically disposed or may be disposed in one ring shape. For example, an electrical circuit is provided on the substrate 71 by each light source 72 and the wiring pattern 71p. The wiring pattern 71p is configured by a plurality of wiring layers, for example.

For example, a light emitting diode (LED) is used as the light source 72. The light source 72 may be, for example, an organic light emitting diode (OLED), an inorganic electroluminescence light emitting element, an organic electroluminescence light emitting element, or the other electroluminescence light emitting element.

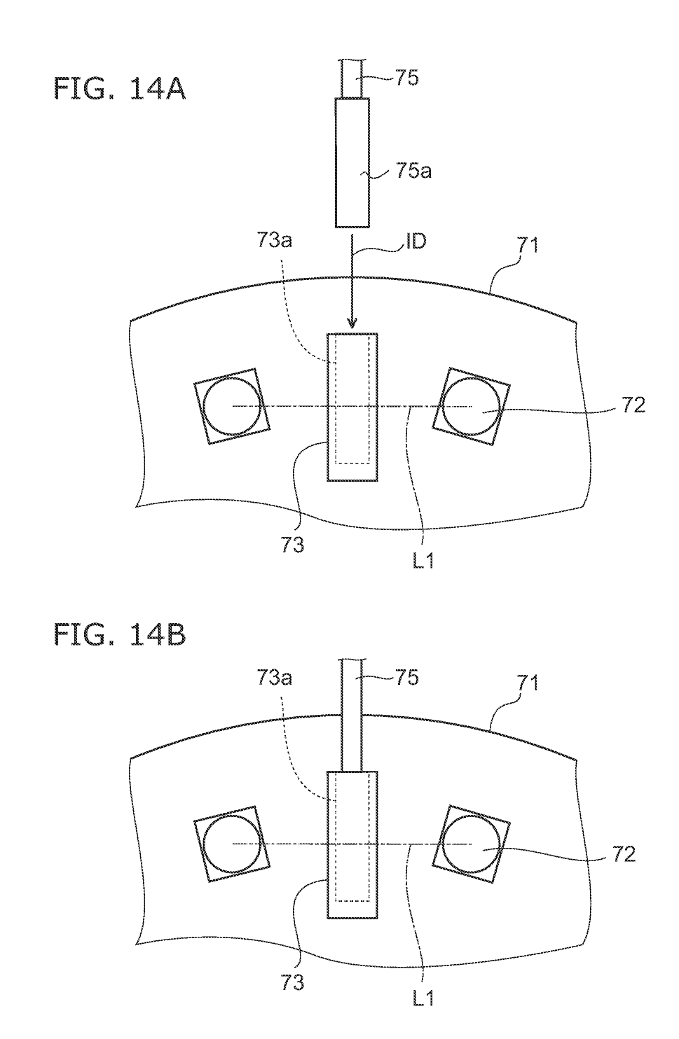

Each connection member 73 is provided on the main surface 71a, holds one end of a wire 75 (see FIG. 14A), and electrically connects a wire and the wiring pattern 71p. In this example, two connection members 73 are provided. A positive electrode wire of the power supply is connected to one connection member 73, for example. A negative electrode wire of the power supply is connected to the other connection member 73, for example. Accordingly, power is supplied to the circuit of the substrate 71 from the outside, through each wire 75 and each connection member 73. Each light source 72 emits light according to power supply from the outside.

A connector or a connection terminal can be used as the connection member 73, for example. In addition, the connection member 73 may be provided as the socket side or may be a plug side, in the connector or the connection terminal. A metal material having high conductivity such as copper is used as the connection member 73, for example. The connection member 73 is formed only of a metal material, for example.

The number of the connection members 73 is not limited to two, and may be three or more. For example, four connection members 73 may be provided so as to supply two channels of power supply. In this case, a pair of connection members 73 which are one channel thereof may be electrically connected to the entire light sources 72, or may also be electrically connected to a part of the light sources 72. The wiring pattern 71p may include a plurality of paths which are electrically insulated. The wire to be connected to the connection member 73 is not limited to the wire for power supply, and for example, may be a wire for inputting a control signal.

An attachment surface 20a for attaching the substrate 71 is provided on the radiator 20. An area of the attachment surface 20a is similar to or slightly larger than an area of the main surface 71a of the substrate 71. The substrate 71 is, for example, adhered to the attachment surface 20a of the radiator 20 through a radiating sheet 29. Accordingly, the light source unit 22 is held by the radiator 20. That is, in this example, the radiator 20 functions as a holding unit which holds the light source unit 22. By holding the light source unit 22 by the radiator 20, heat generated with light emitting from each light source 72, is for example radiated by the radiator 20. For example, it is possible to suppress the effect of the heat on each light source 72. A shape of a surface 29a of the radiating sheet 29 is substantially the same as the shape of the main surface 71a of the substrate 71. An area of the surface 29a of the radiating sheet 29 is slightly larger than the area of the main surface 71a of the substrate 71, for example, and is slightly smaller than the area of the attachment surface 20a of the radiator 20. By adhering the substrate 71 to the radiator 20 through the radiating sheet 29, it is possible to improve adhesiveness of the substrate 71 and the radiator 20, for example. In addition, the radiating sheet 29 has an insulating property. Accordingly, it is possible to suitably secure an insulating distance between the substrate 71 and the radiator 20. In addition, the holding unit is not limited to the radiator 20, and may be an arbitrary member which can hold the light source unit 22.

In this example, the light source unit 22 is configured to be adhered to the radiator 20, however, the light source unit 22 may be, for example, detachably attached to the radiator 20. The light source unit 22 may be exchanged with respect to the lighting apparatus 10.

Optical glass or optical plastic is used for the lens unit 23, for example. The lens unit 23 has optical transparency with respect to the light emitted from the light source 72. The lens unit 23 is, for example, transparent. The lens unit 23 includes a cylindrical tubular unit 23a and a bottom unit 23b which covers one end of the tubular unit 23a, for example. A plurality of lenses 26 are provided on the lens unit 23. The plurality of lenses 26 are provided corresponding to the plurality of light sources 72. Each lens 26 is disposed on a surface of the inside of the bottom unit 23b. Each lens 26 is in a hemispherical shape or in a conical shape, for example. A recess 26a which covers each light source 72 is provided on the top portion of each lens 26. The lens 26 condenses light emitted from the light source 72, for example, and improves irradiation efficiency of the light. The lens 26, for example, controls a light distribution angle of the light emitted from the light source 72. As described above, the holding frame 21 is in a cylindrical shape. The lens unit 23 is fit into the holding frame 21, and is held by the holding frame 21.

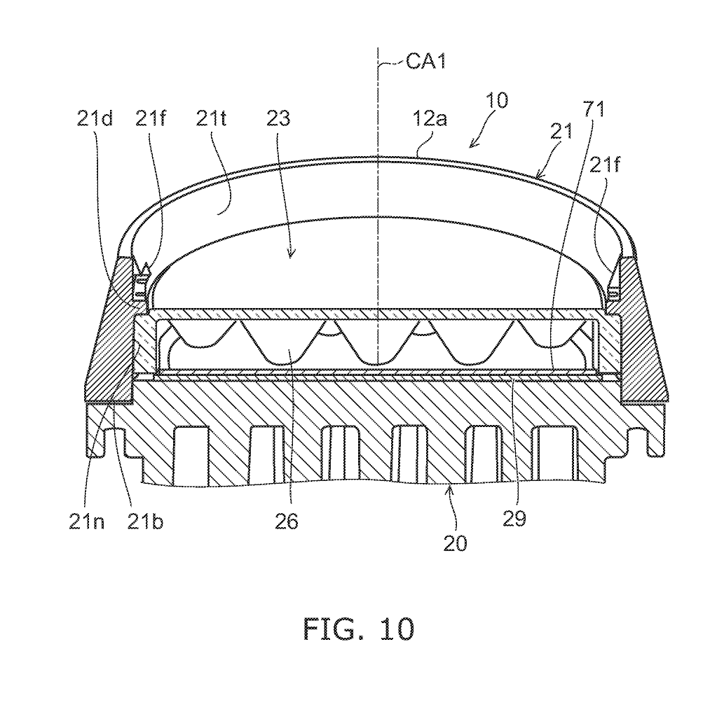

FIG. 10 is a schematic partial cross-sectional view showing the lighting main body according to the exemplary embodiment.

As shown in FIG. 10, a step unit 21d for changing the inner diameter is provided on the inner side surface of the holding frame 21. An inner diameter of a portion 21n between the step unit 21d and a rear end 21b of the inner side surface of the holding frame 21 is substantially the same as the outer diameter of the lens unit 23. The rear end 21b is an end portion on a side opposite to the end portion to be the irradiation window 12a. On the other hand, the inner diameter of the holding frame 21 of the portion of the step unit 21d is smaller than the outer diameter of the lens unit 23. Accordingly, the lens unit 23 which is inserted through the holding frame 21 comes in contact with the step unit 21d, and the releasing thereof from the holding frame 21 is suppressed.

The radiator 20 is attached to the rear end 21b of the holding frame 21. The lens unit 23 inserted through the holding frame 21 is held in a state of being interposed between the holding frame 21 and the radiator 20. A length of the holding frame 21 along the optical axis OA and a length of the lens unit 23 along the optical axis OA are determined according to a length of the lenses 26 along the optical axis OA, for example. The lens unit 23 is held in the holding frame 21, in a state where the position of each light source 72 and each lens 26 is determined.

A portion 21t between the step unit 21d of the inner side surface of the holding frame 21 and the irradiation window 12a is a tapered surface in which an inner diameter continuously becomes larger from the step unit 21d towards the irradiation window 12a. A plurality of filter attachment units 21f for detachably attaching a filter are provided on the portion 21t of the inner side surface of the holding frame 21. In this example, two filter attachment units 21f are provided. Two filter attachment units 21f are provided on a position to be symmetrical with each other with the optical axis OA interposed therebetween. The number of the filter attachment units 21f may be three or more.

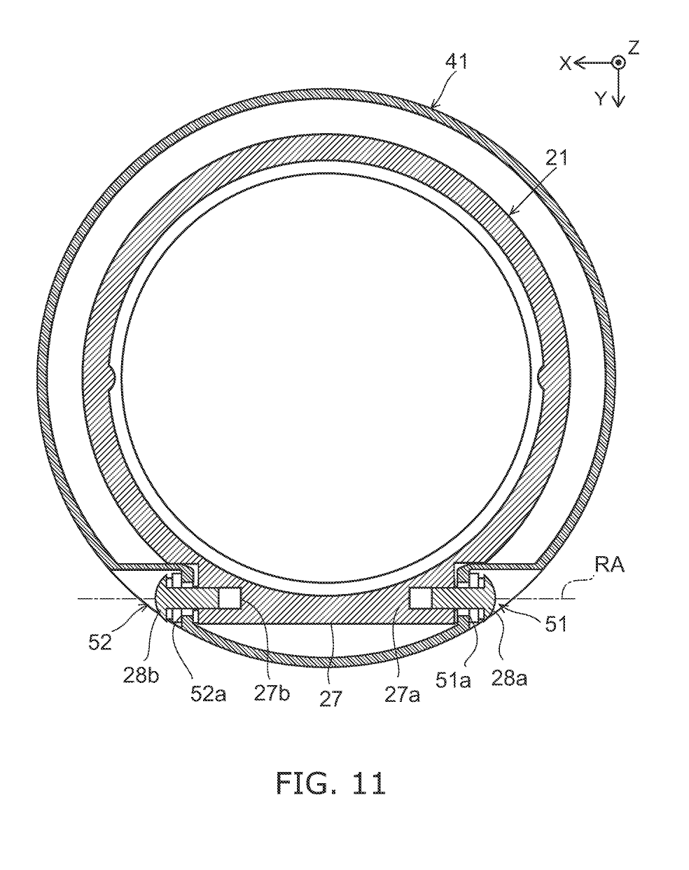

FIG. 11 is a schematic cross-sectional view showing the first frame and the holding frame according to the exemplary embodiment.

As shown in FIGS. 9 and 11, a hinge unit 27 which is raised in a cylindrical shape, is provided on an outer side surface 21g of the holding frame 21. The hinge unit 27 is extended along a direction perpendicular to the optical axis OA. The hinge unit 27 is, for example, raised in the Y axis direction and is extended in the X axis direction. Cylindrical attachment holes 27a and 27b which extend in an extension direction of the hinge unit 27 are provided on both ends of the hinge unit 27. A length of the hinge unit 27 along the X axis direction is determined according to the distance between the pair of bearing units 51 and 52 of the first frame 41 in the X axis direction. The hinge unit 27 is inserted between the bearing units 51 and 52, makes the attachment hole 27a face the penetration hole 51a, and makes the attachment hole 27b face the penetration hole 52a.

A shaft 28a is inserted through the attachment hole 27a and the penetration hole 51a. A shaft 28b is inserted through the attachment hole 27b and the penetration hole 52a. Accordingly, the holding frame 21 is rotatably supported by the first frame 41 in the first rotation direction RD1. A flat-head screw is used as the shafts 28a and 28b, for example,

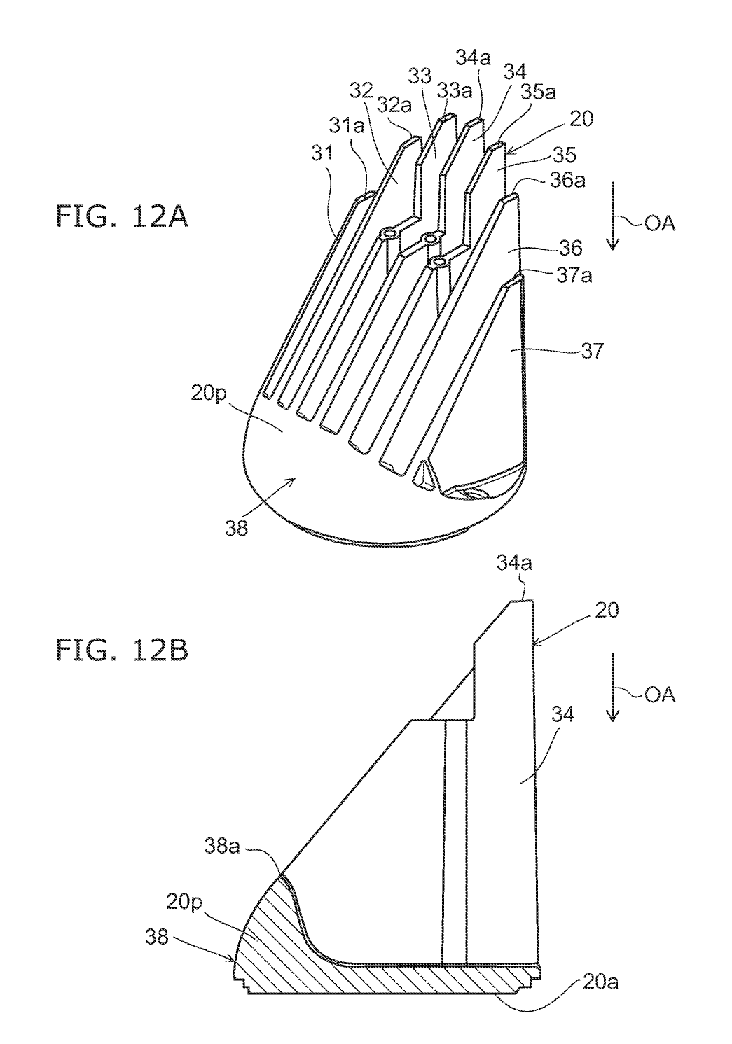

FIGS. 12A and 12B are schematic views showing the radiator according to the exemplary embodiment. FIG. 12A is a schematic perspective view and FIG. 12B is a schematic cross-sectional view.

As shown in FIGS. 12A and 12B, a plurality of flat radiating fins 31 to 37 and a connecting portion 38 are provided on the radiator 20. In this example, seven radiating fins 31 to 37 are provided.

Each of the radiating fins 31 to 37 is extended in a direction parallel with the optical axis OA. In a state where the lighting main body 12 is supported by the first frame 41, each of the radiating fins 31 to 37 is extended in a direction perpendicular to the rotation axis RA (see FIGS. 2A and 2B). Each of the radiating fins 31 to 37 is arranged in a direction parallel with the rotation axis RA. That is, in this example, each of the radiating fins 31 to 37 is extended in a direction parallel with a Y-Z plane, and is arranged in the X axis direction. As described above, by providing the plurality of radiating fins 31 to 37 on the radiator 20, a surface area of the radiator 20 is increased, for example, and it is possible to improve radiating efficiency of the radiator 20. In addition, the number of the radiating fins 31 to 37 to be provided on the radiator 20 is not limited to seven, and may be the arbitrary number of two or more.

The connecting portion 38 is a portion for connecting a part of each of the radiating fins 31 to 37, in the part 20p to be exposed when the lighting main body 12 is positioned in the second position. The connecting portion 38 sets the part 20p to a curved surface, for example. Accordingly, when the lighting main body 12 is positioned in the second position, the connecting portion 38 prevents the shape of each of the radiating fins 31 to 37 from being exposed. That is, the connecting portion 38 is a portion for covering each of the radiating fins 31 to 37, so that each of the radiating fins 31 to 37 is not exposed, when the lighting main body 12 is positioned in the second position. Accordingly, it is possible to improve the appearance of the lighting apparatus 10, for example.

As shown in FIG. 12B, the connecting portion 38 connects only a portion near the outer periphery of each of the radiating fins 31 to 37. Each of the radiating fins 31 to 37 is further extended to the attachment surface 20a side, with respect to an end portion 38a of the connecting portion 38. The thickness of the connecting portion 38 in a direction perpendicular to the optical axis OA and the rotation axis RA increases from the end portion 38a towards the attachment surface 20a side (irradiation window 12a side). The thickness of the connecting portion 38 continuously increases, for example. Accordingly, it is possible to improve moldability of the radiator 20, for example. For example, when molding the radiator 20, it is possible to set the radiator 20 to be easily released from a die. In addition, it is possible to suppress retention of the heat on a rear side of the connecting portion 38, for example.

Each of the end portions 31a to 37a of each of the radiating fins 31 to 37 is protruded to the outside of the first frame 41 and the second frame 42 from the one end 41b of the first frame 41, even when the lighting main body 12 is positioned in the first position or in the second position (see FIGS. 1, 2A, and 2B). For example, when the one end 41b is an upper end, the end portions 31a to 37a are disposed to be upper than the one end 41b and one end of the second frame 42 which is the same side as the one end 41b.

A length of each of the radiating fins 31 to 37 along the optical axis OA decreases in a direction perpendicular to the rotation axis RA and from the rotation axis RA towards the optical axis OA. In addition, a length of each of the radiating fins 31 to 37 along the optical axis OA becomes shorter as being separated from the center, in a direction along the rotation axis RA (X axis direction). That is, in this example, the radiating fin 34 which is positioned in the center of the X axis direction is longest and the radiating fin 31 and radiating fin 37 are the shortest.

Accordingly, even when the lighting main body 12 is positioned in the first position or in the second position, each of the radiating fins 31 to 37 is positioned on the inner side with respect to the outer side surface 42g of the main body unit 42m of the second frame 42, in a direction perpendicular to the second center axis CA2. That is, each of the radiating fins 31 to 37 is positioned on the inner side with respect to the outer side surface 42g, when being projected on a plan (X-Y plan) perpendicular to the second center axis CA2. In this example, each of the radiating fins 31 to 37 is positioned on the inner side with respect to the outer side surface 42g of the main body unit 42m of the second frame 42 in a direction perpendicular to the second center axis CA2 (see FIGS. 2A and 2B).

Accordingly, for example, it is possible to save the space necessary for installing of the lighting apparatus 10. For example, it is possible to save space necessary for a ceiling rear side. In addition, the plurality of lighting apparatuses 10 are installed in a line, in some cases. At that time, when the radiator 20 is protruded to the outside with respect to the outer side surface 42g, when the lighting main body 12 is rotated in the second rotation direction RD2, there is a concern that the radiator 20 comes in contact with the radiator 20 of the adjacent lighting apparatus 10. With respect to this, in the lighting apparatus 10 according to the exemplary embodiment, since the radiator 20 is positioned on the inner side with respect to the outer side surface 42g, even when the plurality of lighting apparatuses 10 are installed in a line, it is possible to smoothly perform adjustment of the direction of the second rotation direction RD2.

In addition, in the lighting apparatus 10 according to the exemplary embodiment, by adjusting the length along the optical axis OA as described above, when the lighting main body 12 is positioned in the second position, each of the radiating fins 31 to 37 does not come in contact with the first frame 41 (see FIG. 2B).

Accordingly, when the lighting main body 12 is positioned in the second position, a gap is generated between the lighting main body 12 and the first frame 41. For example, a path of air is provided to flow from the indoor side to the ceiling rear side, and it is possible to further improve the radiating efficiency when the lighting main body 12 is positioned in the second position,

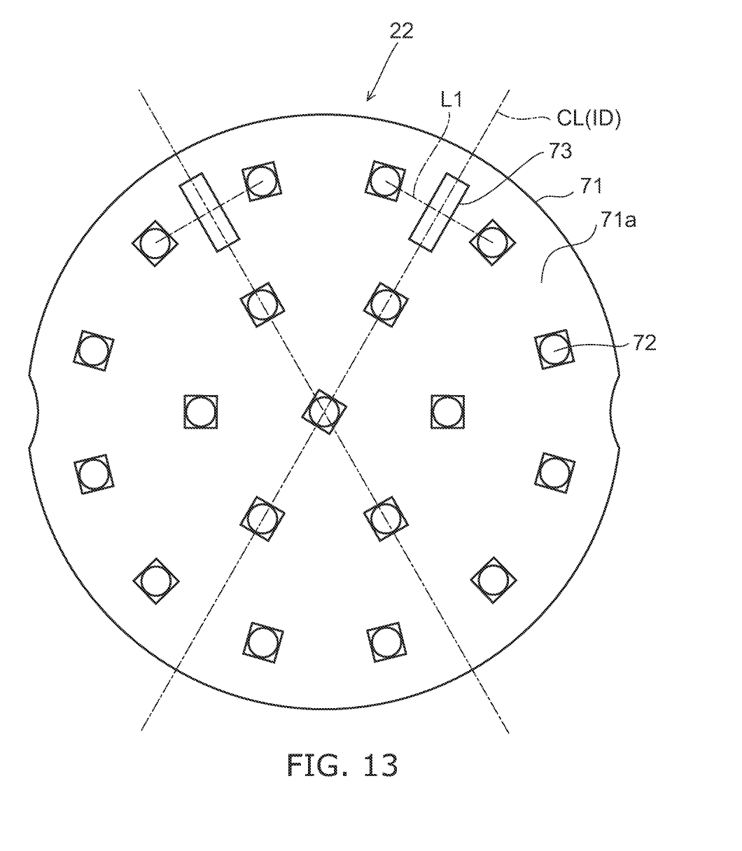

FIG. 13 is a schematic plan view showing the light source unit according to the exemplary embodiment.

FIGS. 14A and 14B are schematic enlarged views showing a part of the light source unit according to the exemplary embodiment.

As shown in FIGS. 13, 14A and 14B, each connection member 73 is disposed between the two adjacent light sources 72. In this example, each light source 72 is concentrically disposed. In this case, each connection member 73 is disposed between two adjacent light sources 72 which are arranged on the outermost periphery.

Each connection member 73 includes an insertion unit 73a capable of being penetrated by one end of the wire 75. In this example, the insertion unit 73a is in a hole shape. That is, in this example, the connection member 73 is a socket. A portion to be inserted 75a having a pin shape according to the shape of the insertion unit 73a is provided on one end of the wire 75. That is, in this example, the portion to be inserted 75a is a plug. The insertion unit 73a may be a pin shaped plug and the portion to be inserted 75a may be a hole shaped socket.

The portion to be inserted 75a is inserted to the insertion unit 73a. Accordingly, one end of the wire 75 is held by the connection member 73. As described above, the connection member 73 holds one wire 75. The connection member 73, for example, extractably holds the one end of the wire 75. The connection member 73 may suppress the releasing of the inserted wire 75 by a snap-fit structure, for example. Without providing the portion to be inserted 75a on the one end of the wire 75, for example, one end of the wire 75 may be held by the connection member 73 by swaging a core of the wire 75.

Each connection member 73 is extended in an insertion direction ID of the one end of the wire 75. A length of each connection member 73 in the insertion direction ID is greater than the length of each connection member 73 in an arbitrary direction perpendicular to the insertion direction ID. As described above, by setting the length thereof to be longer in the insertion direction ID, for example, even in a case where the connection member 73 is miniaturized, it is possible to suppress decrease of the contact area with the portion to be inserted 75a. For example, it is possible to suppress increase of the contact resistance.

Each connection member 73 is disposed between two adjacent light sources 72 so that the insertion direction ID intersects a line L1 connecting the center portions of the two adjacent light sources 72. In this example, the insertion direction ID is parallel with a center line CL of the main surface 71a. The center line CL is a line parallel with the main surface 71a and passing through the center of the main surface 71a.

In addition, in each connection member 73, the insertion unit 73a is disposed towards the outer periphery side of the substrate 71. Accordingly, it is possible to easily insert the portion to be inserted 75a to the insertion unit 73a.

In the light source unit, there is a configuration in which a connector for holding a plurality of wires is provided on a substrate, and electrical connection between the plurality of wires and the wiring pattern of the substrate is performed by one connector (hereinafter, referred to as a multi-core connector). However, for example, with demands for miniaturization or high output of the lighting apparatus, it is difficult to dispose the multi-core connector in a substrate shape. For example, in a case of miniaturizing the apparatus while maintaining the brightness, a gap between light sources becomes narrow with decrease of the substrate area. That is, the space for disposing the mufti-core connector is decreased and it is difficult to dispose the mufti-core connector. In a case of high outputting, the number of wires necessary for power supply is increased with the increase of voltage or current to be supplied. In this case, the size of the multi-core connector itself becomes large and it is difficult to be disposed.

In the lighting apparatus 10 according to the exemplary embodiment, the plurality of connection members 73 which is long in the insertion direction ID is provided on the light source unit 22. Each connection member 73 is disposed between two adjacent light sources 72, so that the insertion direction ID intersects the line L1. Accordingly, in the lighting apparatus 10 according to the exemplary embodiment, when compared to the case of using the multi-core connector, the size of each connection member 73 becomes small and it is possible to efficiently dispose each light source 72 and each connection member 73 on the substrate 71. Even in a case of realizing the miniaturization and the high outputting of the lighting apparatus 10, it is possible to suitably perform mechanical and electrical connection between each wire 75 and the substrate 71.

In addition, in a case of the multi-core connector, it is necessary to cover a contact portions by an insulating material such as a resin for suppressing short circuit. In the lighting apparatus 10 according to the exemplary embodiment, the light source 72 is positioned between two adjacent connection members 73 and it is possible to sufficiently secure the insulating distance. In addition, only one wire 75 is connected to each connection member 73. Accordingly, in the lighting apparatus 10, it is possible to form the connection member 73 only with a metal material. Thus, in the lighting apparatus 10, it is possible to improve heat resistance. For example, it is possible to improve reliability and durability.

FIG. 15 is a schematic cross-sectional view showing a part of the light source unit and the lens unit according to the exemplary embodiment.

As shown in FIG. 15, each connection member 73 is disposed between two adjacent lenses 26. As described above, each connection member 73 is disposed in a gap between each light source 72 and between each lens 26.

For example, in the downlight, a narrow light distribution angle is required. In a case of setting the light distribution angle narrower, the lens becomes larger, and it is difficult to dispose the multi-core connector. With respect to this, in the lighting apparatus 10 according to the exemplary embodiment, even when the lens 26 becomes large, it is possible to suitably dispose each connection member 73. Even when the light distribution angle is set to be narrow, it is possible to suitably perform mechanical and electrical connection between each wire 75 and the substrate 71.

In addition, when there is a space in a gap between the light sources 72 and between the lenses 26, one connection member 73 may hold the plurality of wires 75. In this case, short circuit of each wire 75 is suppressed using an insulating material in the connection member 73. That is, the connection member 73 may contain an insulating material.

In this example, the insertion direction ID is set to be parallel with the center line CL of the main surface 71a, however, the insertion direction ID and the center line CL may not be parallel with each other. The insertion direction ID may be inclined with respect to the center line CL in a range of not interfering each light source 72 or each lens 26. For example, when each light source 72 or each lens 26 are disposed in a circular ring shape, the insertion direction ID and the center line CL are set to be parallel with each other. Accordingly, it is possible to efficiently dispose each light source 72 and each connection member 73.

FIG. 16 is a schematic perspective view showing a filter according to the exemplary embodiment,

FIG. 16 shows a filter 80 which is detachably attached with respect to the lighting main body 12.

As shown in FIG. 16, the filter 80 includes a disc-like filter main body 81, and a plurality of engagement claws 82. The filter 80 is a color rendering filter for improving a color rendering property by cutting a specific wavelength of visible light, for example. The filter 80 may be the other optical filter such as an ND filter or a color filter, for example.

A diameter of the filter main body 81 is substantially the same as the inner diameter of a portion on which each filter attachment unit 21f of the holding frame 21 is provided, for example. A side surface 81s of the filter main body 81 is a tapered surface, for example. An angle of the side surface 81s is substantially the same as the angle of the portion 21t of the tapered surface of the holding frame 21, for example.

The plurality of engagement claws 82 are provided corresponding to the plurality of filter attachment units 21f of the holding frame 21. Accordingly, in this example, two engagement claws 82 are provided. Each engagement claw 82 is provided to be protruded to a radial direction from the side surface 81s of the filter main body 81. In this example, each engagement claw 82 is in a rectangular shape. The shape of each engagement claw 82 may be an arbitrary shape so as to be attached to each filter attachment unit 21f. The position of each engagement claw 82 corresponds to the position of each filter attachment unit 21f. In this example, each engagement claw 82 is provided on a position to be symmetric with each other by interposing the center of the filter main body 81 therebetween. A hemispherical protrusion 82a is provided on each engagement claw 82. The protrusion 82a is provided on a surface facing an optical axis direction of the engagement claw 82.

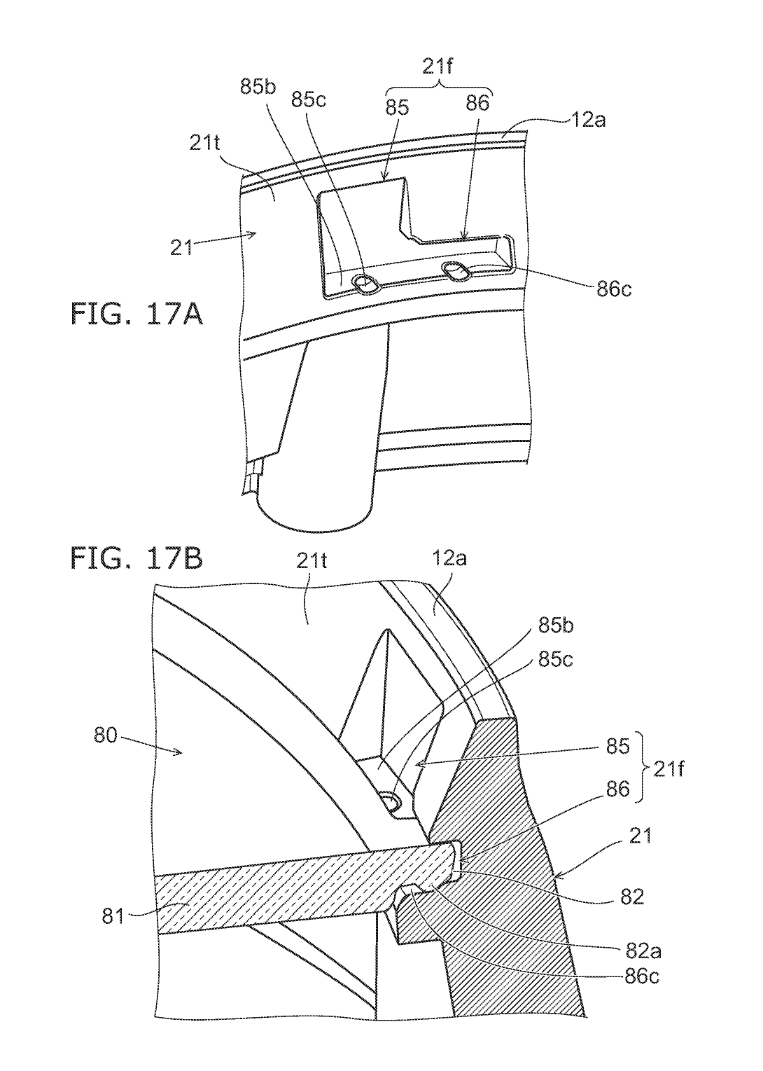

FIGS. 17A and 17B are schematic perspective views showing the holding frame according to the exemplary embodiment.

As shown in FIGS. 17A and 17B, the filter attachment unit 21f includes an insertion-extraction unit 85 and an engagement groove 86.

The insertion-extraction unit 85 is a portion obtained to be substantially parallel with the optical axis OA by recessing of a part of the portion 21t of the tapered surface of the holding frame 21. The depth of the insertion-extraction unit 85 (recessed amount of the holding frame 21 from the inner side surface) corresponds to a length of the engagement claw 82 of the filter 80 (protruded amount from the side surface 81s). Accordingly, in the insertion-extraction unit 85, it is possible to insert and extract the engagement claws 82 from the irradiation window 12a side in the optical axis direction. A recess 85c engaged with the protrusion 82a of the engagement claw 82 is provided on a bottom portion 85b of the insertion-extraction unit 85.

The engagement groove 86 is extended from the bottom portion 85b of the insertion-extraction unit 85 in the circumferential direction. The height of the engagement groove 86 is slightly greater than the thickness of the engagement claw 82. A recess 86c engaged with the protrusion 82a of the engagement claw 82 is provided on the engagement groove 86.

In a case of attaching the filter 80, each engagement claw 82 is inserted to the insertion-extraction unit 85 of each filter attachment unit 21f to insert the filter 80 through the holding frame 21. Each engagement claw 82 is pressed to the bottom portion 85b of each insertion-extraction unit 85 to rotate the filter 80 around the optical axis. Each engagement claw 82 is inserted into each engagement groove 86 to engage each protrusion 82a and each recess 86c. Accordingly, as shown in FIG. 17B, the releasing of the filter 80 to the optical axis direction is regulated by the engagement of each engagement claw 82 and each engagement groove 86, and the rotation of the filter 80 around the optical axis is regulated by the engagement of each protrusion 82a and each recess 86c, and the filter 80 is held by each filter attachment unit 21f.

In a case of detaching the filter 80, each engagement claw 82 is extracted from each engagement groove 86 by rotating the filter 80 in a direction opposite to the direction at the time of the attachment, and each engagement claw 82 is extracted from each insertion-extraction unit 85 to the irradiation window 12a side.

As described above, in the lighting apparatus 10, with a simple operation of rotating the filter 80 around the optical axis, it is possible to easily attach and detach the filter 80 to and from the holding frame 21. In addition, the filter 80 can be suitably held by each filter attachment unit 21f, by the engagement of each engagement claw 82 and each engagement groove 86, and the engagement of each protrusion 82a and each recess 86c. In a reverse way of the above case, the recess may be provided on the engagement claw 82 and the protrusion may be provided on the insertion-extraction unit 85 and the engagement groove 86. In addition, the shape of the protrusion is not limited to the hemispherical shape, and may be an arbitrary shape capable of performing engagement.

As described above, in the lighting apparatus 10 according to the exemplary embodiment, it is possible to efficiently dispose each light source 72 and each connection member 73 on the substrate 71.

In the support 14 according to the exemplary embodiment, the lighting main body 12 is supported rotatably in the first rotation direction RD1 and the second rotation direction RD2. The support may support the lighting main body rotatably only in the first rotation direction RD1. The support may support the lighting main body rotatably only in the second rotation direction RD2. In this case, for example, the first frame may support the lighting main body, in a state (state of the second position) where the optical axis OA of the irradiation light is inclined with respect to the first center axis CA1 In addition, in the exemplary embodiment, the universal type lighting apparatus 10 which can change the irradiation direction of the irradiation light is shown, however, the irradiation direction of the irradiation light may be fixed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting apparatus comprising:
a light source unit including
a substrate including a main surface and a wiring pattern,
a plurality of light sources which are arranged on the main surface in a circular pattern, and are electrically connected to the wiring pattern, and
a plurality of connection members, each of which is provided on the main surface, includes an insertion unit capable of being penetrated by one end of a wire, and holds the one end of the wire to electrically connect the wire and the wiring pattern; and
a holding unit which holds the light source unit,
each of the plurality of connection members being extended in an insertion direction of the one end of the wire and is disposed between two adjacent light sources, and
the insertion direction intersecting with a line segment which connects center portions of the two adjacent light sources.

2. The apparatus according to claim 1, wherein the insertion direction is parallel with a center line of the main surface.

3. The apparatus according to claim 1, further comprising
a plurality of lenses provided corresponding to the plurality of light sources,
wherein each of the plurality of connection members is provided between the two adjacent lenses.

4. The apparatus according to claim 1, wherein a metal material is used for each of the plurality of connection members.

5. The apparatus according to claim 1, wherein each of the plurality of connection members includes the insertion unit which is disposed to face an outer periphery side of the substrate.

6. The apparatus according to claim 1, wherein a length of each of the plurality of connection members in the insertion direction is greater than a length of each of the plurality of connection members in a direction perpendicular to the insertion direction.

7. The apparatus according to claim 1,
wherein the plurality of light sources are disposed in a concentric annular manner, and
each of the plurality of connection members is disposed between the two light sources which are arranged on the outermost periphery.

8. The apparatus according to claim 1, wherein the insertion unit is in a hole shape.

9. The apparatus according to claim 1, further comprising
a support which supports the holding unit,
wherein the support includes a first tubular frame capable of being penetrated by the holding unit,
the first frame rotatably supports the inserted holding unit around a rotation axis which extends in a direction perpendicular to a center axis of the first frame, and moves the holding unit to a first position and a second position,
in the first position, an optical axis of light emitted from each of the plurality of light sources is parallel with a center axis of the first frame, and
in the second position, the optical axis is inclined with respect to the center axis.

10. The apparatus according to claim 9,
wherein the support includes a second tubular frame capable of being penetrated by the first frame, and
the second frame rotatably supports the first frame around a center axis of the second frame.

11. The apparatus according to claim 10,
wherein the support includes a rotation stopper member which is engaged with a protrusion provided on the first frame to regulate the rotation of the first frame, and
the rotation stopper member is movably attached to the second frame in a circumferential direction of a circle having the center axis of the second frame as the center, and moves to a first regulation position in which the rotation of the first frame in one direction around the center axis of the second frame is regulated, and to a second regulation position in which the rotation of the first frame in the other direction is regulated.

12. The apparatus according to claim 11,
wherein the second frame includes a rotation stop attachment unit for attaching the rotation stopper member,
the rotation stop attachment unit includes a protrusion which extends along a circumferential direction of a circle having the center axis of the second frame as the center, and
the rotation stopper member includes a long hole capable of being penetrated by the protrusion, and moves to the first regulation position and the second regulation position in a range of the long hole.

13. The apparatus according to claim 12, wherein a holding member which suppresses releasing of the rotation stopper member from the protrusion is attached to the rotation stop attachment unit.

14. The apparatus according to claim 11, wherein the rotation amount of the rotation of the first frame around the center axis of the second frame is equal to or more than 360°.

15. The apparatus according to claim 10, wherein the second frame coaxially supports the first frame.

16. The apparatus according to claim 9,
wherein the holding unit is a radiator, and
the radiator extends in a direction parallel with the optical axis, extends in a direction perpendicular to the rotation axis, and includes a plurality of radiating fins which are arranged in a direction parallel with the rotation axis.

17. The apparatus according to claim 16,
wherein the rotation axis is separated from the center axis, in a second direction perpendicular to each of the center axis of the first frame and to a first direction,
each end portion of the plurality of the radiating fins is protruded to the outer side of the first frame and the second frame,
lengths of the plurality of radiating fins along each optical axis decrease in a direction perpendicular to the rotation axis and towards the optical axis from the rotation axis, and
at any time when the radiator is positioned in the first position or positioned in the second position, each of the plurality of radiating fins is positioned in an inner side with respect to the outer side surface of the second frame in a direction perpendicular to the center axis of the second frame.

18. The apparatus according to claim 17, wherein each of the plurality of radiating fins does not come in contact with the first frame, when the radiator is positioned in the second position.

19. The apparatus according to claim 1, wherein each of the plurality of light sources is a light emitting element.

20. A light source unit, comprising:
a substrate including a main surface and a wiring pattern;
a plurality of light sources which are arranged on the main surface in a circular pattern, and are electrically connected to the wiring pattern; and
a plurality of connection members, each of which is provided on the main surface, includes an insertion unit capable of being penetrated by one end of a wire, and holds the one end of the wire to electrically connect the wire and the wiring pattern; and
each of a plurality connection members being extended in an insertion direction of the one end of the wire and is disposed between the two adjacent light sources, and
the insertion direction intersecting with a line segment which connects center portions of the two adjacent light sources.
